(19) United States
(12) Patent Application Publication
(10) Pub. No.: US 2005/0169477 A1
(43) Pub. Date: Aug. 4, 2005

(54) Wireless interface for removable digital content security devices

(76) Inventors: Richard R. Green, Boulder, CO (US); Joseph W. Weber, Louisville, CO (US)

Correspondence Address: PATTON BOGGS, 1660 LINCOLN ST, SUITE 2050, DENVER, CO, 80264, US

(21) Appl. No.: 10/769,274

(22) Filed: Jan. 30, 2004

(51) Int. Cl. H04K 1/00

(52) U.S. Cl. 380/270

(57) ABSTRACT

The present wireless interface for removable digital content security devices adds a wireless interface to the Removable Digital Content Security Device so that content can be sent over a limited range transmission to other televisions or consumer electronics devices that may be located a short distance from the first television or consumer electronics device, or do not have compatible connectors with the first device.

### FIELD OF THE INVENTION

This invention relates to a Removable Digital Content Security Device (RDCSD) that is used to pass decrypted content to a plurality of televisions or other consumer electronics devices.

### Problem

It is a problem in the field of cable television distribution systems to transform the received encrypted content and deliver the decrypted content to multiple televisions or consumer electronics devices. Existing Removable Digital Content Security Devices pass decrypted content only to a single television or consumer electronics device. To pass that content to other televisions or consumer electronics devices, the first television or consumer electronics device must have an output connector that is compatible with the connector on the other television or consumer electronics device so the two systems can be interconnected. If the other television or consumer electronics device does not have a compatible connector, it is not able to receive the decrypted digital content. In addition, the second television or consumer electronics device may be located some physical distance away from the first television or consumer electronics device, for example in another part of the house, and therefore it may be impractical or impossible to have a cable physically interconnect the two televisions or consumer electronics devices.

### Solution

The above-described problems are solved and a technical advance achieved by the present wireless interface for removable digital content security devices which interconnects a plurality of televisions or consumer electronics devices via a wireless interface. The use of a wireless interface overcomes the problems associated with the distance between the systems and the connector compatibility.

The present wireless interface for removable digital content security devices adds a wireless interface to the Removable Digital Content Security Device so that content can be sent over a limited range transmission to other televisions or consumer electronics devices that may be located a short distance from the first television or consumer electronics device, or do not have compatible connectors with the first device.

### BRIEF DESCRIPTION OF THE DRAWING

FIG. 1 illustrates, in block diagram form, the typical use of an existing Removable Digital Content Security Device;

FIG. 2 illustrates, in block diagram form, the present wireless interface for removable digital content security devices and a typical application of this device; and

FIG. 3 illustrates, in block diagram form, a typical implementation of the wireless interface for use with Removable Digital Content Security Devices.

### DETAILED DESCRIPTION

The Society of Cable Telecommunication Engineers in the SCTE 28 2003 standard has defined a Removable Digital Content Security Device interface for Cable Television. The Removable Digital Content Security Device provides removable content security for television sets and other consumer electronics video devices. This interface functions to receive encrypted program content from a source, decrypt the program content, and deliver the decrypted program content to a television or consumer electronics device. Multi-channel Video Program Distributors (MVPDs), including Cable TV operators, typically purchase and deploy Removable Digital Content Security Devices for their customers' use in consumer electronics devices.

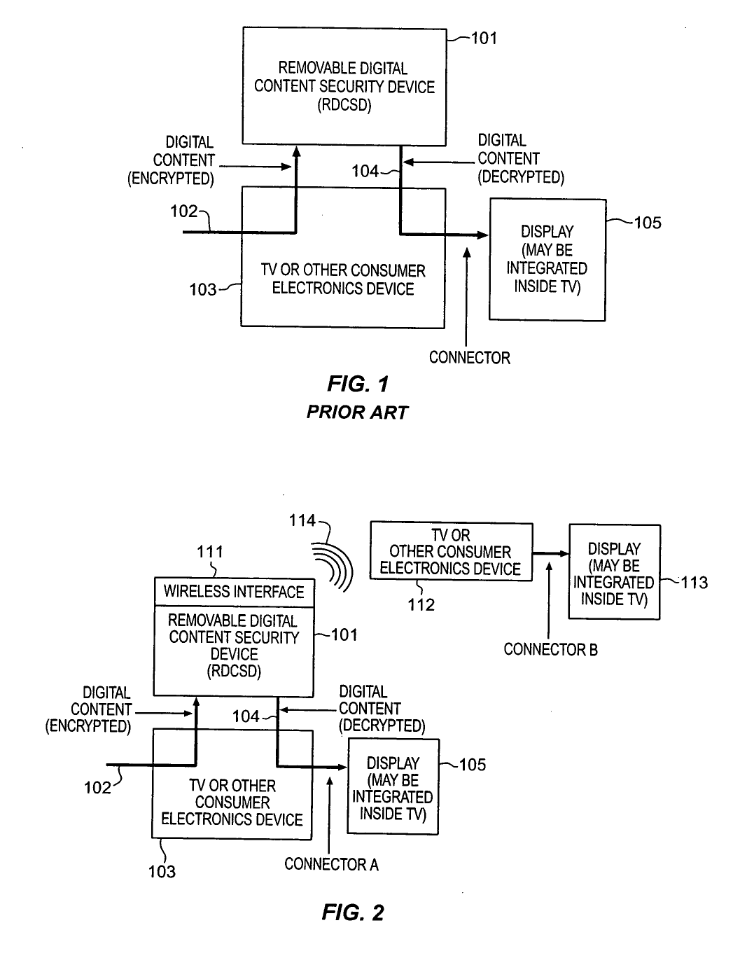

FIG. 1 illustrates, in block diagram form, the typical use of an existing Removable Digital Content Security Device (RDCSD) 101 which provides removable security of digital content for television sets and other consumer electronics devices. A service provider, such as a cable television provider, transmits program content 102 over a transmission medium in scrambled or encrypted form to authorized receiving devices, such as a television or other consumer electronics devices 103 (collectively termed “consumer electronics devices” herein) that is equipped with a Removable Digital Content Security Device. The program content received by the consumer electronics device 103 is passed to the Removable Digital Content Security Device 101 for decryption and the decrypted program content 104 is returned to the consumer electronics device 103 for delivery to the consumer. The consumer electronics device either displays 105 the program content or passes the program content to another consumer electronics device for display. The delivery of the decrypted program content 104 to another consumer electronics device 105 is accomplished via the physical interconnection of the consumer electronics device 103 that is equipped with a Removable Digital Content Security Device 101 to the other consumer electronics device 105. This physical interconnection is effected via the use of a set of cables that plug into both systems to thereby carry the decrypted program content 104 from the consumer electronics device 103 that is equipped with a Removable Digital Content Security Device 101 to the other consumer electronics device 105.

FIG. 2 illustrates, in block diagram form, the present wireless interface 111 for Removable Digital Content Security Devices 101 and a typical application of this device. In particular, the Removable Digital Content Security Device 101 is equipped with a wireless component 111 that retransmits the decrypted program content 114 over a limited transmission distance to other consumer electronics device(s) 113. The wireless transmitter component 111 of the Removable Digital Content Security Device 101 is matched by a wireless receiver component in the other consumer electronics device 113.

Thus, the present wireless interface 111 for Removable Digital Content Security Devices solves the problem of needing separate Removable Digital Content Security Devices 101 for every device in the home that wants to receive protected content. A single Removable Digital Content Security Device 101 operating with the present wireless interface 111 for Removable Digital Content Security Devices can be shared by multiple devices. In addition, the use of a wireless link among these devices removes the constraint of having to physically interconnect the devices with a cable.

Implementation Example

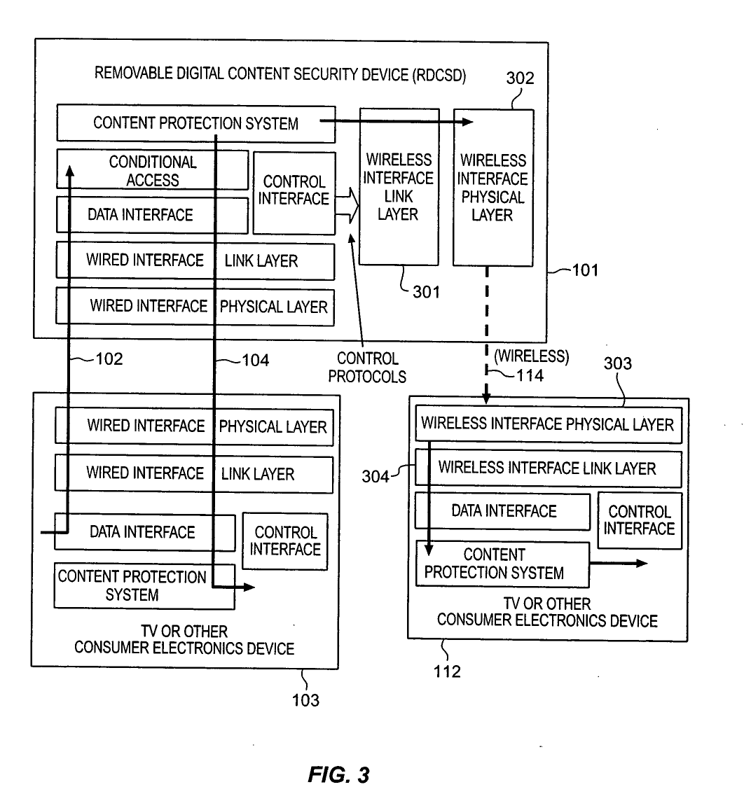

FIG. 3 illustrates, in block diagram form, a typical implementation of the wireless interface 111 for use with Removable Digital Content Security Devices 101. The unnumbered blocks of FIG. 3 are functional elements common to existing Removable Digital Content Security Devices 101 and consumer device implementations. For example, the published Open Cable set of specifications defines those Removable Digital Content Security Device elements necessary for digital cable television content. Items 301-304 of FIG. 3 are functional elements of wireless interface 111 using any of a number of wireless data protocols, such as the IEEE 802.11x set of standards and represent the elements of the wireless interface 111 for Removable Digital Content Security Devices 101 which are necessary to interconnect the functional elements common to existing Removable Digital Content Security Devices 101 and the functional blocks of the wireless interface 111. The wireless interface for Removable Digital Content Security Devices creates protocols between wireless interface components and the data and security elements of the Removable Digital Content Security Devices 110 such that content can be sent wirelessly between the Removable Digital Content Security Devices 101 and consumer devices 113. Those protocols include, but are not limited to:
Device Discovery—finding and connecting to Consumer Electronics devices using the same wireless interface link and physical layer protocols.
Device Identification—Identifying which of those wireless devices are capable of receiving the content.
Session Management—common communication protocols must be defined between the Removable Digital Content Security Devices and the receiving device. These including initiating a session, maintaining a session, and tearing down a session of communications.
Authentication—Before sending protected content, the receiving device must be authenticated by the Removable Digital Content Security Devices.
Content Protection Key Exchange—Messages are sent between the Removable Digital Content Security Devices and the authenticated receiving device containing keys such that protected content can be decrypted on the receiving end.
Link Management—As content is sent from the Removable Digital Content Security Devices to the receiving device, the wireless link must be monitored for loss or degradation of signal.

Thus, the addition of the wireless interface overcomes the problems associated with the distance between the systems and the connector compatibility.

1. A wireless interface for Removable Digital Content Security Devices for delivering a stream of decrypted program content to a plurality of consumer electronics devices, comprising:
security device means, connected to a first consumer electronics device, for receiving a stream of encrypted program content from a source;
decryption means for converting said received encrypted program content to decrypted program content; and
wireless transmitter means for wirelessly transmitting said decrypted program content to at least one other consumer electronics device.

2. The wireless interface of claim 1 further comprising:
wireless receiver means, located in a one of said at least one other consumer electronics device, for receiving said decrypted program content for use in said one of said at least one other consumer electronics device.

3. The wireless interface of claim 1 wherein said wireless transmitter means implements wireless link layer and wireless physical layer protocols.

4. A method of using a wireless interface for Removable Digital Content Security Devices for delivering a stream of decrypted program content to a plurality of consumer electronics devices, comprising:
receiving in a security device, connected to a first consumer electronics device, a stream of encrypted program content from a source;
decrypting said received encrypted program content to decrypted program content; and
wirelessly transmitting said decrypted program content to at least one other consumer electronics device.

5. The method of using a wireless interface of claim 4 further comprising:
receiving in a wireless receiver, located in a one of said at least one other consumer electronics device, said decrypted program content for use in said one of said at least one other consumer electronics device.

6. The method of using a wireless interface of claim 4 wherein said step of receiving in a wireless receiver implements wireless link layer and wireless physical layer protocols.
